(19) United States
(12) Patent Application Publication
(10) Pub. No.: US 2008/0143476 A1
(43) Pub. Date: Jun. 19, 2008

(54) Physimetric authentication of physical object by digital identification (DID)

(75) Inventors: Siu Keung Kwok, Hung Hom (HK); Chi Fai Cheung, Hung Hom (HK); Hing Choi Tsang, Hung Hom (HK); Wing Bun Lee, Hung Hom (HK); Burly K. Tan, Hung Hom (HK); Pui Him Ng, Hung Hom (HK)

Correspondence Address: ATTN: Maquita Wong;The Hong Kong Polytechnic University, Suite 600, Mailbox #119, 1800 Diagonal Road, Alexandria, VA, 22314, US

(73) Assignee: The Hong Kong Polytechnic University, Hung Hom (HK)

(21) Appl. No.: 11/638,504

(22) Filed: Dec. 14, 2006

(51) Int. Cl. G05B 19/00

(52) U.S. Cl. 340/5.8

(57) ABSTRACT

The present invention relates a scanable product made of a physical object and an ID Container, such ID Container possessing on its memory a Unique ID and a stored coded locking mechanism. The stored coded locking mechanism is generated by inputting physimetric property of the physical object and its Unique ID into hash functions to create an unintelligible code. Methods of making such a scanable product, and methods of authenticating a scanable product are also taught.

### BACKGROUND

Radio Frequency Identification (RFID) is currently used in anti-counterfeit solutions, however they have critical limitations. As the RFID is assumed to represent the identity of a product, if the RFID tag is proved to be genuine, the product is assumed to be genuine. Unfortunately, if a genuine tag can be attached to an imitation or counterfeit product, or if an RFID tag is cloned from a genuine RFID tag and placed on an imitation product, current RFID-based anti-counterfeit systems would authenticate the imitation or counterfeit product as a genuine one. This limitation is particularly unacceptable in industries such as the jewelry or medicine industries where it is difficult to permanently attached an RFID tag to a product.

Physimetric authentication can be applied to anti-counterfeit systems. Physimetric identification is an automated method of verifying and recognizing the identity or authenticity of a physical object based on that object's physical properties. The use of physimetric identification as applied to process control operations would allow an identification device to become part of an object as opposed to merely attached to it. Physimetric authentication can make sure that the RFID tag and the product attached to it are a unique pair. However, physimetric authentication in and of itself may not fully protect the cloning of RFID tags as the information on the tag may be deciphered by readers and scanners. The incorporation of additional security measures with physimetric authentication would create tags that are part of an object and that are significantly more safe from cloning.

It is an object of the present system to overcome these and other disadvantages in the prior art.

### SPECIFICATION

The present invention proposes a scanable product made of physical object and ID Container, methods of making such physical object, and methods of authenticating physical objects with attached ID Containers.

The physical objects made in accordance with the instant invention possess ID Containers, such ID Containers having stored therein Unique ID's specific to the physical object and coded locking mechanism. The physical objects of the present invention allow authentication of the physical object to be based not only on the genuineness of the ID Container, but also the genuineness of the physical object.

Methods of making physical objects in accordance with the present invention involve obtaining the physical object and attaching to it an ID Container possessing a Unique ID and a coded locking mechanism. The ID Container is made by obtaining a Unique ID code and capturing physimetric property of the physical object, inputting the Unique ID code and the captured physimetric property into a conversion algorithm, generating a coded locking mechanism, inserting the Unique ID on the ID Container, and then locking the ID Container with the coded locking mechanism.

The present invention also teaches a method of authenticating a physical object, whereby a physical object with an ID Container attached, such ID Container possessing a Unique ID and stored coded locking mechanism, enters a read zone wherein the Unique ID is read and physimetric property of the physical object is captured, inputting the Unique ID and physimetric property into a conversion algorithm to generate a coded locking mechanism, then comparing the ID Container stored coded locking mechanism with the newly generated coded locking mechanism. Comparison occurs through comparison algorithms stored on the memory of a controlling device.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention. It should be expressly understood that the drawings are included for illustrative purposes and do not represent the scope of the present system.

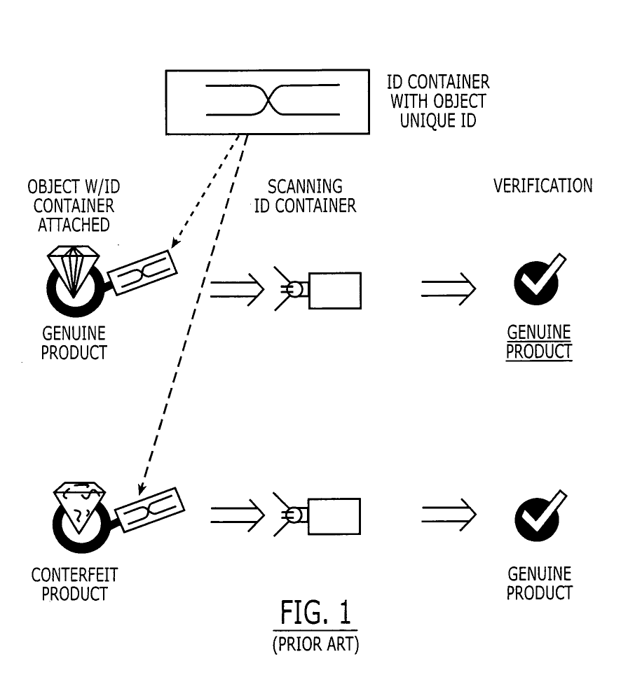

FIG. 1 shows a method of physical object authentication as used in the prior art.

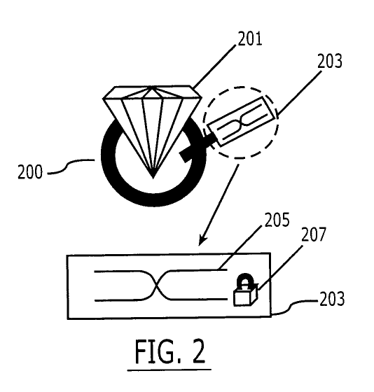

FIG. 2 shows physical object with ID Container made in accordance with the instant invention.

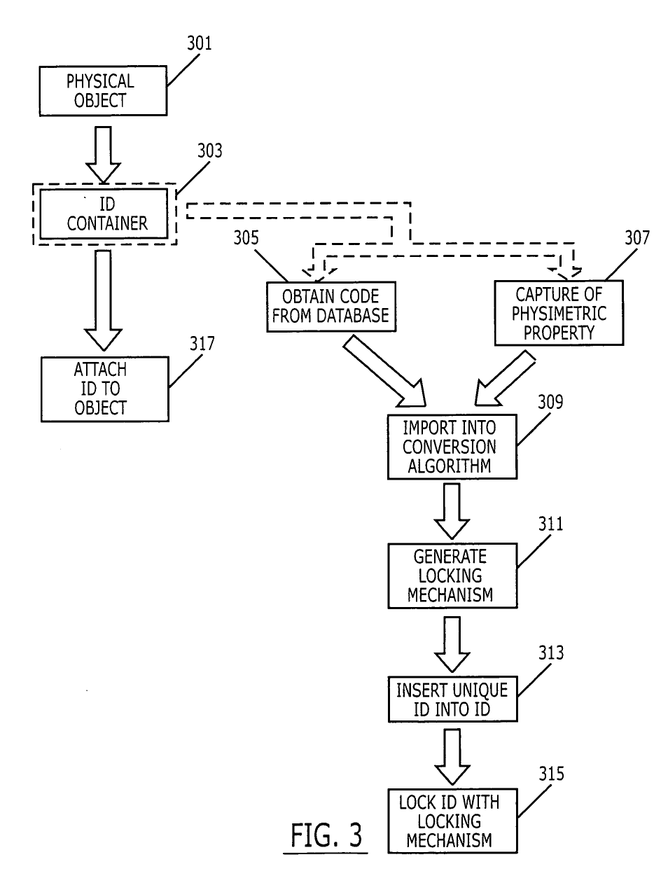

FIG. 3 shows a method of attaching an ID Container possessing Unique ID and coded locking mechanism.

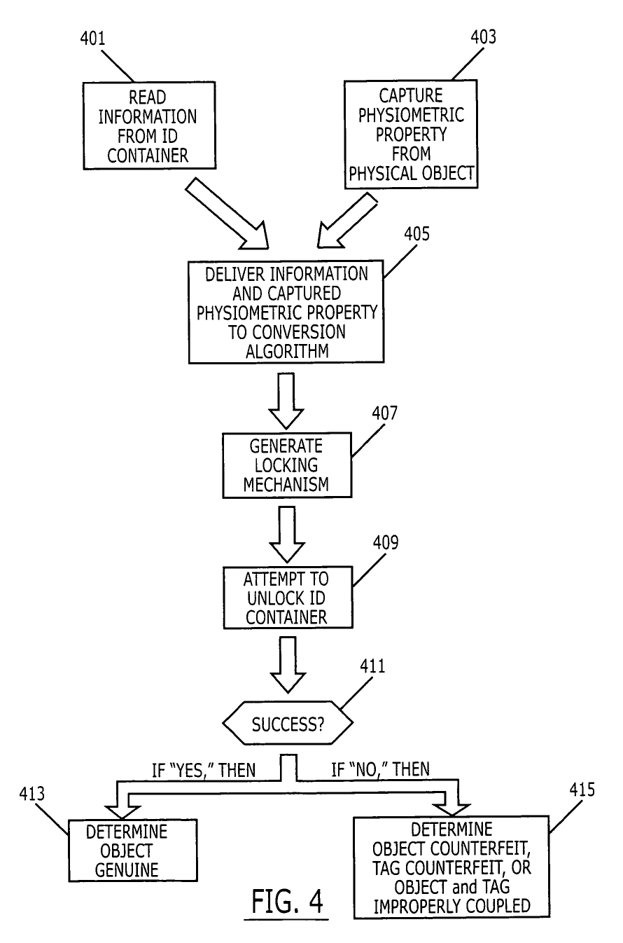

FIG. 4 shows a method of authenticating a physical object with an attached ID Container possessing a Unique ID and coded locking mechanism.

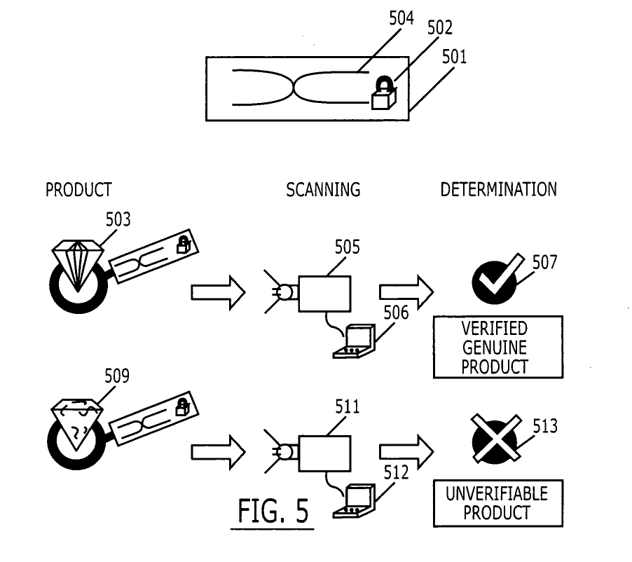

FIG. 5 shows an example of the instant invention whereby a physical object containing an ID Container is authenticated.

As used herein, “authentication” shall refer to the genuineness such as determination of an object or claim. Characteristics of the physical object to be authenticated shall include purity, quantity, quality, freshness, source of the physical object, and composition of the physical object.

“Physical object” shall refer to bulk, single products or objects, or discrete products, such products or objects being bundled individually or in batches, such products or objects totally or partially matching one another in terms of physimetric properties, such products or objects being solid, liquid, gaseous, or combinations thereof.

### “Physimetric” shall refer to a physical objects' physical properties, including but limited to dimensions, weight, mass, color, shape, size, pattern, substrate material, light reflective/refractive index, or design.

### “Read zone” shall refer to the area covered by a electromagnetic field generated by an interrogator or reader.

### “Interrogator” shall refer to any transceiver capable of transmitting to and receiving signals from a transponder such as a RFID tag, Smartcard, or barcode.

“Controlling device” shall refer to any device suitable for operating an interrogator within a read zone, for example a computer. The controlling device may be a computer including a laptop or table top computer, handheld device such as a pda, or operating panel, and generally contains a microprocessor, interface device, power source, memory, and input/output means such as wires or wireless technology.
“Locking” shall refer to the process that the generated coded locking mechanism is stored into an ID container's memory according the ID container's international standards, for example EPC, or ISO of RFID, in order to provide a lock for unlocking of physimetric authentication. For example, in EPC Class 1 RFID, some memory, i.e., access code, which is invisible and inaccessible by the end-user can be used as a password to secure the RFID tag. Therefore, the generated coded locking mechanism can be stored into the memory of access code to lock the RFID tag. Another example in ISO 18000-6B RFID, apart from memory reserved for unique ID, there is additional memory for additional information which can be used for the storage of generated coded locking mechanism to lock the RFID tag.
“Unlocking” shall refer to the process that a coded locking mechanism is generated by the captured unique ID and measured Physimetric properties from the physical object, and then it attempts to validate the ID container by comparing the generated coded locking mechanism to the stored coded locking mechanism inside the ID container.

FIG. 1 is an example of the prior art relating to digital identification.

FIGS. 2-5 are embodiments of the present invention.

FIG. 1 shows the concept of authentication of a physical object through the use of an ID Container. As shown in FIG. 1, an ID Container, with a Unique ID specific to a particular object, is attached to the object. Upon scanning of the ID Container, which may occur when the object is purchased, the object is determined to be genuine based solely on the ID Container. In other words, the ID Container determines the authenticity of the product. Because ID Containers can easily be removed and ID Containers cannot permanently be attached to objects without decreasing their value, this method is ripe for manipulation by would be counterfeiters who would attach a genuine ID Container to a fake object.

FIG. 2 is a scanable product in accordance with the instant invention, wherein the scanable product 200 contains a physical object 201 and an attached ID Container 203, wherein said ID Container 203 has stored therein a Unique ID 205 and a coded locking mechanism 207.

Physical objects 201 suitable for the instant invention can include jewelry, such as rings, earrings, stone-settings, etc., pharmaceuticals including over-the-counter medicines, prescription medicines, electronics including cameras, radios, pda's, etc., visual works such as paintings, sculptures, clothing, and any other object that can be manufactured, mined, and/or sold in wholesale or retail environments for whom authentication of its genuineness is an issue. Such objects may be packaged individually or in bulk.

The ID container 203 can be, for example, radio-frequency ID (RFID) tags, barcodes, Smartcards, etc. Such ID Container may be active, semi-passive, or passive. In the event that it is active, the ID container 203 will contain its own power source as commonly known in the art. The tags as taught in U.S. Pat. Nos. 3,859,624, 3,878,528, 4,095,214, 4,354,099, 4,475,481, 4,549,264, and 4,739,328, are suitable for use herein. A suitable ID Container may be chip based or chipless, or combinations of both chip based and chipless technologies. The ID Container 203 shall include a memory, and one or more antennas. Alternatively, the ID Container 203 may also contain a power source and a silicon chip. The ID Container may be attached to the object 201 by means such as a string, hook and loop, clip-on, and/or adhesive. In one embodiment, the attachment means is non-permanent allowing the ID Container to be disattached from the physical object 201.

Memory on the ID Container 203 shall be encoded therein to include a Unique ID 205 and a coded locking mechanism 207. The Unique ID 205 can be represented by a code made of serial numbers, words, letters, combinations thereof, etc. in whatever length suitable for identifying the physical object 201 to which the Unique ID 205 pertains. The Unique ID 205 may be designed by a manufacturer, wholesaler, or retailer, or may be randomly chosen from a database. The Unique ID 205 may be stored on the memory in accordance with different identification technology standards, for example Electronic Product Code (EPC), Serial Shipping Container Code (SSCC), Global Location Number (GLN), International Organization for Standardization (ISO) standards for RFID, Smartcards, etc. The Unique ID 205 may be specific to a single, individual physical object 201 such as a unit, a line of physical objects such as a product line, or a collection of lines of physical objects 201. The Unique ID 205 shall represent the physical object, and be stored on the memory of the ID Container 203 to be attached to the physical object 201.

The coded locking mechanism 207, stored on the memory of the ID Container 203, is used in comparison algorithms to determine if the physical object 201 is authentic. The coded locking mechanism 207 is generated following input of the Unique ID 205 and coded physimetric property of the physical object 201 into a conversion algorithm. The coded locking mechanism 207 can be a code made of a series of letters, words, or numbers, and combinations thereof in whatever length desired. In one embodiment, the coded locking mechanism 207 is unintelligible to the human being, i.e., incapable of being logically understood. Example of such coded locking mechanism is,
9e107d9d372bb6821bd8135421a419d6

The coded physimetric property can be represented by numbers, words, letters, combinations thereof, etc. The coded physimetric can be based on one or more physical attributes of the physical object from which it is derived. For example, the physimetric property for a diamond may be its refractive index, which can be determined by a light measuring device. In a further example, the physimetric property for a medicine may be its size and weight, which may be determined by weighing the medicine and measuring one pill.

In one embodiment, both the Unique ID 205 and coded physimetric may be stored on the memory of the ID Container 203 as a continuous unit, for example a complete string of letters, numbers, etc., or in a manner where the Unique ID and coded physimetric property are demarcated from one another by a hypen, period, comma, slash, etc. The Unique ID 205 may be placed in front of the coded physimetric, or vice versa.

Conversion algorithms to generate the coded locking mechanism 207 can be hash functions. Such hash functions may have the properties of being determinate, have strong mixing property, avoid “collisions” between two message digests, and have functionality. Examples of hash functions that would be suitable in the instant invention include Message-Digest algorithm 5 (MD5), Secure Hash Algorithms (SHA) including SHA-0, SHA-1, SHA-2245, SHA-256, SHA-384, and SHA-512; MD4, RIPE MD-160, RIPEMD-128, RIPEMD-256, and RIPEMD-320. Other functions suitable for the present invention include Checksums, Cyclic redundancy checks (CRCs), message authentication code (MAC), hash message authentication code (HMAC), and pseudorandom number generators (PRGs). The conversion algorithms are stored on the memory of a controlling device.

FIG. 3 is a method of making a physical object with an ID Container in accordance with the instant invention, wherein a physical object is obtained 301 and an ID Container is attached thereto 317, whereby said ID Container possesses an Unique ID and a coded locking mechanism.

In the present method, a physical object is first obtained 301. The physical object can be obtained immediately following manufacture. Alternatively, the physical object can be delivered to a retailer or wholesaler immediately prior to attachment of an ID Container 317. In the event the physical object is a raw product, the physical object may be obtained following its being mined, found, sequenced, developed, produced and/or composed.

Then, prior to attachment 317, the ID Container is made 303. In making the ID container 303, a Unique ID associated specifically with the physical object is obtained from a database 305. Such database may be stored on the memory of a controlling device. In another embodiment, the Unique ID is designed or selected by the manufacturer, retailer, or wholesaler of the object. Simultaneously or following obtaining a Unique ID 305, physimetric property of the physical object is captured 307.

Physimetric property may be captured 307 by a capturing device. The capturing device can include, for example, scales, lasers, lights, optical measuring instruments such as spectrophotometric equipment, rulers, etc. For example, if capturing the weight of the physical object is necessary, a scale may be used to allow the physical object to rest thereon. If capturing the light reflective/refractive index of the physical object is necessary, a laser or light may be positioned such that it pinpoints the physical object. One or more capturing devices may be used to capture the physimetric property. One or more physimetric properties may be captured at one time. The capturing device can also include a microprocessor for delivering instructions and receiving feedback from the physical object, a memory for storing the feedback, and a connection to the controlling device.

In one embodiment, the capturing of the physimetric property is performed through two or more cycles, i.e., the physimetric property is captured once, then the physimetric is captured a second time, then the physimetric property may be captured subsequent more times. For example, the weight of the physical object is determined once, then determined a second time, then determined a third time. In this embodiment, the captured physimetric property can be determined to be accurate.

The obtained Unique ID 305 and captured physimetric property 307 are then input into a conversion algorithm 309. Such conversion algorithm can be stored on the memory of a controlling device. As previously stated in FIG. 2, such conversion algorithms may be hash functions. Inputting the Unique ID and physimetric property, they may first be stored on a database stored on the controlling device and then passed to the conversion algorithm. The input may be automatic or require manual authorization from the programmer of the ID Container.

Following input to the conversion algorithm 309, a coded locking mechanism is then generated 311. The locking mechanism is a code created by the functionality of the conversion algorithm. An example of a suitable generated locking mechanism would be;

MD5 hash function,
<?php
$string=‘PHP & Information Security’;
printf(“Original string: %s\n”, $string);
printf(“MD5 hash: %s\n”, md5($string));
printf(“SHA-1 hash: %s\n”, sha1($string));
?>

### Following the insert of the Unique ID and coded physimetric property, the generated coded locking mechanism would be,

Original string: PHP & Information Security
MD5 hash: 88dd8f282721af2c704e238e7f338c41

The Unique ID previously obtained from the database 305 is then stored on the memory of the ID Container 313. Storing may occur by directly passing the Unique ID from the database to the ID Container via the microprocessor.

The coded locking mechanism is then stored on the memory of the ID Container 315. This can be performed through password algorithms stored on the controlling device, for example,
<?php
$passwordHash=sha1($_POST[‘password’]);
$sql=‘INSERT INTO user (username,passwordHash) VALUES (?,?)’;
$result=$db->query($sql, array($_POST[‘username’], $passwordHash));
?>
   Storing the coded locking mechanism on the ID Container could occur by automatically passing the generated coded locking mechanism from the conversion algorithm to the ID Container. Alternatively, the programmer of the ID Container may input the coded locking mechanism into the ID Container manually, such as utilizing a user interface to enter the coded locking mechanism. Examples of user interfaces included keyboard, mouse, laser pointer, pdas devices, etc. The ID Container is attached to the physical object, such as by adhesion, string, hook and loop. In one embodiment, the attachment is non-permanent.

FIG. 4 is a method whereby an object with an ID Container of the instant invention is authenticated. Authentication occurs when information stored on the ID Container is read 401, physimetric property from the physical object is captured 403, the information and the captured physimetric property are delivered to the conversion algorithm 405, a coded locking mechanism is generated by the conversion algorithm 407, an attempt is made to unlock the ID Container 409, and a determination is made as to whether or not an object is genuine 413/415.

The information read from the ID Container 401 consists of the stored Unique ID. Reading occurs by having the physical object enter a read zone 401. The physical object may enter the read zone through manual manipulation, i.e., someone picks up and places the physical object within the read zone, or via automated method, such as conveyor belt. The read zone includes a detecting device, including one or more interrogators, for example RFID interrogators, barcode readers, scanners, lasers, etc. The detecting device may consist of interrogators that are similar, or two or more different kinds of interrogators. In general, the interrogators consist of circuitry to communicate with the ID Container, a microprocessor to check and decode data, storage means for storing data, and one or more antennas to receive signals. In the event the ID Container is passive, i.e., lacking a power source, the interrogator may also include a power source for instituting communication with the ID Container. In the case of the ID Container being RFID-based container, the interrogator shall contain radio circuitry, microprocessor, memory, and one or more antennas. Interrogators as set forth in U.S. Pat. No. 6,917,291, incorporated herein by reference, are suitable for use in the instant method. The detecting device is generally connected to a controlling device. The detecting device may be handheld device, or mounted device.

The capturing of the physimetric property of the physical object 403 can occur through a capturing device. Examples of suitable capturing devices include scales, lasers, lights, optical measuring instruments such as spectrophotometric equipment, rulers, etc. For example, if capturing the weight of the physical object is necessary, a scale may be placed on the floor in the read zone to allow the physical object to rest thereon. If capturing the light reflective/refractive index of the physical object is necessary, a laser or light may be positioned such that it pinpoints the physical object upon its entering the read zone. One or more capturing devices may be used to capture the physimetric properties. The capturing device can also include a microprocessor for delivering instructions and receiving feedback from the physical object, a storage for storing the feedback, and a connection to the controlling device.

The Unique ID read from the ID Container and the captured physimetric property are then input into the conversion algorithm stored on the memory of the controlling device 405. The Unique ID and physimetric property may first be stored on a database stored on the controlling device and then passed to the conversion algorithm. The input may be automatic or require manual authorization from the programmer of the ID Container. As previously stated, the conversion algorithm can be hash functions, for example MD5 or SHA-1.

A coded locking mechanism is then generated by the conversion algorithm 407. The locking mechanism may be any length, may be a collection of numbers or letters, and may be blocks of collection of numbers or letters. The locking mechanism is then stored on the memory of the controlling device.

Through comparison algorithms, an attempt is made to unlock the ID Container 409 by comparing the generated locking mechanism 407 to the ID Container stored locking mechanism. Such comparison algorithms can be based on conditional statements, such as IF-THEN clauses, switch statements, statements with guards, and IF-THEN-ELSE statements, etc. For example, IF generated locking mechanism

```
            equal stored locking mechanism
          THEN
            “YES”
or,
          IF generated locking mechanism
            not equal stored locking mechanism
          THEN
            “NO”
```

The result from the comparison algorithm will be delivered to the operator, such as by audible signal, visual signal, or a combination thereof. Delivery may be made to computer screens, audio speakers, light display, etc. If the result is “Yes” 413, i.e., according to the comparison algorithm, the generated locking mechanism is equal to the stored locking mechanism, the physical object will be authenticated and passed forward through the read zone. If the result is “No” 415, i.e., according to the comparison algorithm, the generated locking mechanism is not equal to the stored locking mechanism, the controlling device will stop automation and the physical object will be detained in the read zone. A “YES” determination indicates that the physical object is genuine. A “NO” determination indicates that the physical object is counterfeit, the ID Container is counterfeit, or the ID Container and physical object are improperly coupled. A “NO” determination may be followed by the physical object being removed from the read zone for further scrutiny.

FIG. 5 is an example of a method of the present invention, whereby an ID Container 501 with a Unique ID specific to a product 504 and a stored locking mechanism 502 is attached to different product 503/509. Upon entering a read zone, the ID Container 501 is scanned 505/511 to read the Unique ID and the physimetric property of the product is captured, the Unique ID and physimetric property are delivered to a conversion algorithm stored on the controlling device 506/512, and a coded locking mechanism is generated. The generated locking mechanism is compared to the ID Container stored coded locking mechanism, and a determination 507/513 is made, through comparison algorithms stored on the controlling device, whether the product is genuine. In the case of one product 503, it is determined to be genuine 507. In the case of the second product 509, it is determined to be unverifiable or counterfeit.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be compromised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A scanable product, comprising
a physical object,
and an attached ID Container,
wherein said ID Container contains a Unique ID and coded locking mechanism.

2. The scanable product of claim 1, wherein said attached ID Container is non-permanent.

3. The scanable product of claim 1, wherein said coded locking mechanism is unintelligible.

4. The scanable product of claim 1, wherein said physical object can be selected from the group consisting of jewelry, pharmaceuticals, electronics, visual works, manufactured objects, or mined objects.

5. A method of making a scanable product, comprising
obtaining a physical object;
making an ID Container in accordance with the steps of a-f,
a) obtaining a Unique ID,
b) capturing the physimetric property of said physical object,
c) inputting said Unique ID and said physimetric property into a conversion algorithm,
d) generating a coded locking mechanism,
e) storing said Unique ID on the memory of said ID Container,
f) locking said ID Container with a coded locking mechanism,
and,
attaching said ID Container to said physical object.

6. The method of claim 5, wherein obtaining a physical object comprises manufacturing said physical object.

7. The method of claim 5, wherein obtaining a physical object comprising mining said physical object.

8. The method of claim 5, wherein obtaining a Unique ID comprises accessing a database.

9. The method of claim 5, wherein capturing said physimetric property comprises determining the physical properties of said physical object, coding said determined physical properties, and delivering said coded physical properties to a controlling device.

10. The method of claim 5, wherein generating said coded locking mechanism comprises using hash functions stored on the memory of a controlling device.

11. The method of claim 5, wherein storing said coded locking mechanism on said ID Container occurs through the use of password algorithms stored on the memory of a controlling device.

12. The method of claim 5, wherein attaching said ID Container to said physical object is non-permanent.

13. The method of authenticating a tagged product, comprising
entering a physical object with an ID Container possessing Unique ID and stored coded locking mechanism into a read zone;
reading information from said ID Container;
capturing the physimetric property of said physical object;
inputting said information of said physimetric property into conversion algorithm;
generating a coded locking mechanism;
attempting to unlock said ID Container;
and
determining whether said ID Container is authentic.

14. The method of claim 13, wherein reading information from said ID Container comprises reading the Unique ID stored on said ID Container.

15. The method of claim 13, wherein capturing the physimetric property of said physical object comprises utilizing a capturing device.

16. The method of claim 13, wherein generating a coded locking mechanism comprises using hash functions stored on the memory of a controlling device.

17. The method of claim 16, wherein said hash functions are based on Secured Hash Algorithms.

18. The method of claim 16, wherein attempting to unlock the ID Container comprises comparing the generated coded locking mechanism with an ID Container stored coded locking mechanism.

19. The method of claim 18, wherein said comparison occurs through comparison algorithms stored on said memory of said controlling device.

20. The method of claim 19, further comprising
if said coded locking mechanism is equal to said ID Container stored locking mechanism, then passing said physical object through said read zone,
or
if said coded locking mechanism is not equal to said ID Container stored locking mechanism, then detaining said physical object.
